(19) United States
(12) Patent Application Publication
(10) Pub. No.: US 2021/0297007 A1
(43) Pub. Date: Sep. 23, 2021

(54) CONTROL DEVICE FOR POWER CONVERSION APPARATUS

(71) Applicant: YANMAR POWER TECHNOLOGY CO., LTD., Osaka (JP)

(72) Inventors: Tomohiro Sawano, Osaka (JP); Kazuki Iwamura, Osaka (JP); Shimpei Kitano, Osaka (JP)

(73) Assignee: YANMAR POWER TECHNOLOGY CO., LTD., Osaka (JP)

(21) Appl. No.: 17/263,684

(22) PCT Filed: Aug. 1, 2019
(86) PCT No.: PCT/JP2019/030331

§ 371 Date: Jan. 27, 2021

(30) Foreign Application Priority Data
Aug. 23, 2018 (JP) 2018-156430

(51) Int. Cl. H02M 7/539; H02M 1/32

(52) U.S. Cl. CPC H02M 7/539; H02M 1/32

(57) ABSTRACT

A power conversion apparatus 1 has an inverter for converting DC power into AC power. This control device for the power conversion apparatus includes: a current limiting unit for limiting a target current value to a predetermined limit value or less when the target current value is greater than the limit value; and a control unit for controlling the inverter on the basis of the target current value after the current limiting performed by the current limiting unit.

### TECHNICAL FIELD

The present invention relates to a control device for a power conversion apparatus.

### BACKGROUND ART

There is a case where, when a private power generator that interconnects systems drives an electric motor such as a water pump used for firefighting water during an autonomous operation such as during a power outage, an inrush current becomes excessive due to an influence of a starting current of the electric motor, which implements an overcurrent protection function and stops the private power generator. In Patent Literature 1 below, a technique of suppressing the inrush current by gradually increasing an indicated voltage in a system-interconnection power supply device having an autonomous operation function in an autonomous operation mode has been disclosed.

### CITATION LIST

### Patent Literature

Patent Literature 1: Japanese Unexamined Patent Application Publication No. 2009-131056

### DISCLOSURE OF INVENTION

### Problems to be Solved by the Invention

However, the technique disclosed in Patent Literature 1 gradually increases the instructed voltage in a uniform manner during the autonomous operation. Thus, there is a problem of poor voltage responsiveness at an initiation of the autonomous operation. There is also a problem that after the instructed voltage converges to a constant value, a motor load cannot additionally be started.

An object of the present invention is to provide a control device for a power conversion apparatus, the control device capable of suppressing an overcurrent from flowing through the power conversion apparatus when a load is connected to the power conversion apparatus.

### Means for Solving the Problems

A control device for a power conversion apparatus according to this invention is a control device for a power conversion apparatus including an inverter that converts DC power into AC power, and includes: a current limiting unit that limits a target current value to be equal to or smaller than a specified limit value when the target current value is larger than the limit value; and a control unit that controls the inverter on the basis of the target current value after current limit processing by the current limiting unit.

With this configuration, in the case where a load is connected to the power conversion apparatus, the target current is limited to be equal to or smaller than the limit value even when the target current becomes larger than the limit value. Thus, it is possible to suppress an overcurrent from flowing to the power conversion apparatus. As a result, it is possible to suppress an overcurrent protection function from being implemented and stopping actuation of the power conversion apparatus.

In one aspect of the present invention, a PI control unit is further provided to calculate the target current value by performing a proportional integration calculation on a deviation between a specified target output voltage and an output voltage of the power conversion apparatus. The current limiting unit is configured to limit the target current value to be equal to or smaller than the limit value and stop updating of an integral operation amount by the PI control unit when the target current value is larger than the limit value.

With this configuration, when the target current is limited, updating of the integral operation amount is stopped. Thus, it is possible to prevent the integral operation amount, which is calculated by using the output voltage controlled by the limited target current, from being accumulated in the PI control unit. As a result, it is possible to prevent the integral operation amount from being calculated by using the unreliable past integral operation amount when the target current is no longer limited.

The above-described and/or further other objects, characteristics, and effects of the present invention will be clarified by the following description on the embodiment with reference to the accompanying drawings.

### BRIEF DESCRIPTION OF DRAWINGS

FIG. 1 is a block diagram illustrating a power conversion apparatus and a control device that controls the power conversion apparatus.

FIG. 2 is a flow chart illustrating operation of a target current limiting unit.

FIG. 3 is a schematic graph for illustrating processing in step S4 of FIG. 2.

### DESCRIPTION OF EMBODIMENTS

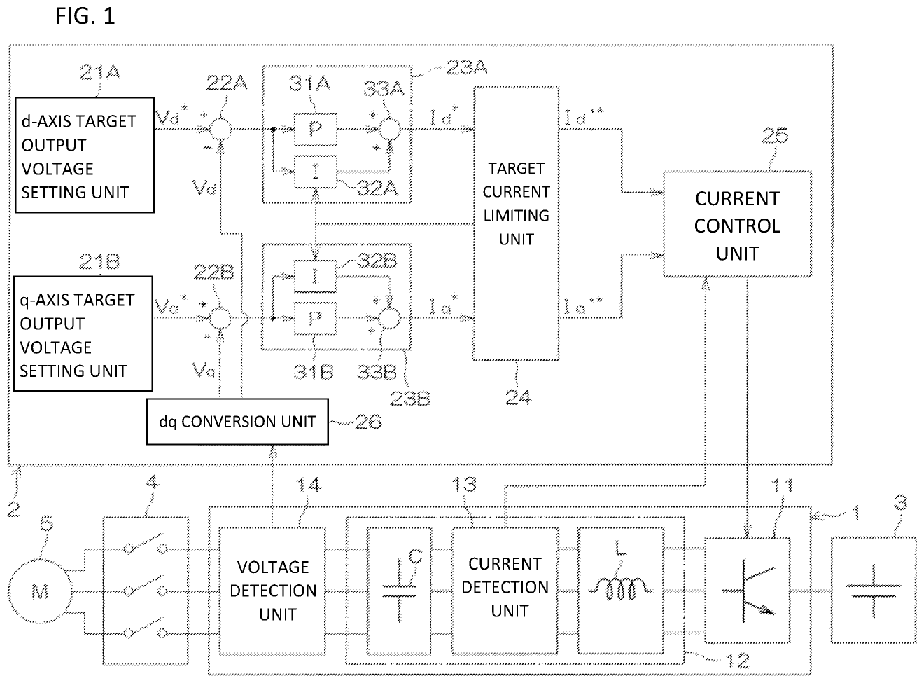

FIG. 1 is a block diagram illustrating a power conversion apparatus 1 and a control device 2 that controls the power conversion apparatus 1.

The power conversion apparatus 1 includes: an inverter 11 that converts DC power supplied from a DC power supply 3 into AC power; and an LC filter 12 provided on an output side of the inverter 11.

The DC power supply 3 may be configured to include, for example: an engine; a generator that is driven by the engine; and a rectifier that converts the AC power generated by the generator into the DC power.

In this embodiment, the inverter 11 is constructed of a three-phase inverter circuit that includes a plurality of switching elements. The switching elements are constructed of an insulated-gate bipolar transistor (IGBT), for example. The LC filter 12 is provided to remove high-frequency noise that is contained in output of the inverter 11. The LC filter 12 includes: reactors L, each of which is connected to respective one of three-phase (U, V, and W phases) output lines of the inverter 11; and a capacitor C that is connected between two each of the three-phase output lines of the inverter 11 in a subsequent stage of these reactors L.

A current detection unit 13 for detecting a current that flows through the reactor L (a reactor current) is provided between the reactor L and the capacitor C. In the subsequent stage of the LC filter 12, a voltage detection unit 14 is provided to detect a voltage between the output lines in the power conversion apparatus 1.

The power, which is output from the inverter 11 and the noise of which is removed by the LC filter 12, is output of the power conversion apparatus 1. A motor 5 as a load is connected to an output terminal of the power conversion apparatus 1 via a switch 4. In this embodiment, the switch 4 is always off, and is turned on in the event of a power outage, for example.

The control device 2 is constructed of a microcomputer. The microcomputer includes a CPU and memory (ROM, RAM, non-volatile memory, or the like) and functions as multiple function processing units by running a specified program.

The multiple function processing units include: a d-axis target output voltage setting unit 21A and a q-axis target output voltage setting unit 21B; a d-axis voltage deviation calculation unit 22A and a q-axis voltage deviation calculation unit 22B; a d-axis proportional integration (PI) control unit 23A and a q-axis PI control unit 23B; a target current limiting unit 24; a current control unit 25; and a dq conversion unit 26.

The d-axis PI control unit 23A and the q-axis PI control unit 23B are examples of the PI control unit in the invention of the present application. The target current limiting unit 24 is an example of the current limiting unit in the invention of the present application. The current control unit 25 is an example of the control unit in the invention of the present application.

The dq conversion unit 26 calculates a p-axis output voltage V_{d} and a q-axis output voltage V_{q} from an output line voltage of the power conversion apparatus 1 detected by the voltage detection unit 14. The d-axis output voltage V_{d} that is obtained by the dq conversion unit 26 is applied to the d-axis voltage deviation calculation unit 22A, and the q-axis output voltage V_{q} that is obtained by the dq conversion unit 26 is applied to the q-axis voltage deviation calculation unit 22B.

The d-axis target output voltage setting unit 21A sets a d-axis target output voltage V_{d}* that corresponds to a target value of an output voltage of the power conversion apparatus 1. The q-axis target output voltage setting unit 21B sets a q-axis target output voltage V_{q}* that corresponds to the target value of the output voltage of the power conversion apparatus 1.

The d-axis voltage deviation calculation unit 22A calculates a deviation ΔV_{d} (=V_{d}*−V_{d}) between the d-axis target output voltage V_{d}* and the d-axis output voltage V_{d}. The q-axis voltage deviation calculation unit 22B calculates a deviation ΔV_{q} (=V_{q}* −V) between the q-axis target output voltage V_{q}* and the q-axis output voltage V_{q}.

The d-axis PI control unit 23A performs a proportional integration calculation (a PI calculation) on the d-axis voltage deviation ΔV_{d} that is calculated by the d-axis voltage deviation calculation unit 22A to calculate a d-axis target current I_{d}*. The q-axis PI control unit 23B performs the PI calculation on a q-axis voltage deviation ΔV_{q} that is calculated by the q-axis voltage deviation calculation unit 22B to calculate a q-axis target current I_{q}*.

More specifically, the d-axis and q-axis PI control units 23A, 23B include proportional elements 31A, 31B, integral elements 32A, 32B, and adders 33A, 33B, respectively.

The proportional elements 31A, 31B respectively perform proportional calculations on the voltage deviations ΔV_{d}, ΔV_{q} so as to each calculate an operation amount of proportional operation (hereinafter referred to as a “proportional operation amount”). More specifically, the proportional elements 31A, 31B calculate the proportional operation amounts by multiplying the voltage deviations ΔV_{d}, ΔV_{q} by proportional gains K_{pd}, K_{pq}.

The integral elements 32A, 32B perform integral calculations on the voltage deviations ΔV_{d}, ΔV_{q} so as to each calculate an operation amount of integral operation (hereinafter referred to as an “integral operation amount”). More specifically, the integral elements 32A, 32B calculate the current integral operation amounts by adding the last integral operation amounts to values that are calculated by multiplying the voltage deviations ΔV_{d}, ΔV_{q} by integral gains K_{id}, K_{iq}.

The proportional operation amounts, which are calculated by the proportional elements 31A, 31B, and the integral operation amounts, which are calculated by the integral elements 32A, 32B, are provided to the adders 33A, 33B.

The adder 33A calculates the d-axis target current I_{d}* by adding the proportional operation amount, which is calculated by the proportional element 31A, and the integral manipulation amount, which is calculated by the integral element 32A. The adder 33B calculates the q-axis target current I_{q}* by adding the proportional operation amount, which is calculated by the proportional element 31B, and the integral operation amount, which is calculated by the integral element 32B.

The target current limiting unit 24 executes limit processing for limiting the d-axis target current I_{d}* and the q-axis target current I_{q}*. A detailed description on the operation of the target current limiting unit 24 will be made below.

A d-axis target current I_{d}′* and a q-axis target current I_{q}′* after the limit processing by the target current limiting unit 24 are applied to the current control unit 25. The current control unit 25 controls each of the switching elements in the inverter 11 such that each of the target currents applied by the target current limiting unit 24 matches the detected current (the reactor current) detected by the current detection unit 13.

Although not illustrated, the control device 2 includes an overcurrent protection function to stop actuation of the power conversion apparatus 1 by turning off all the switching elements in the inverter 11 when the reactor current becomes equal to or higher than an overcurrent determination threshold.

Next, a detailed description will be made on operation of the target current limiting unit 24.

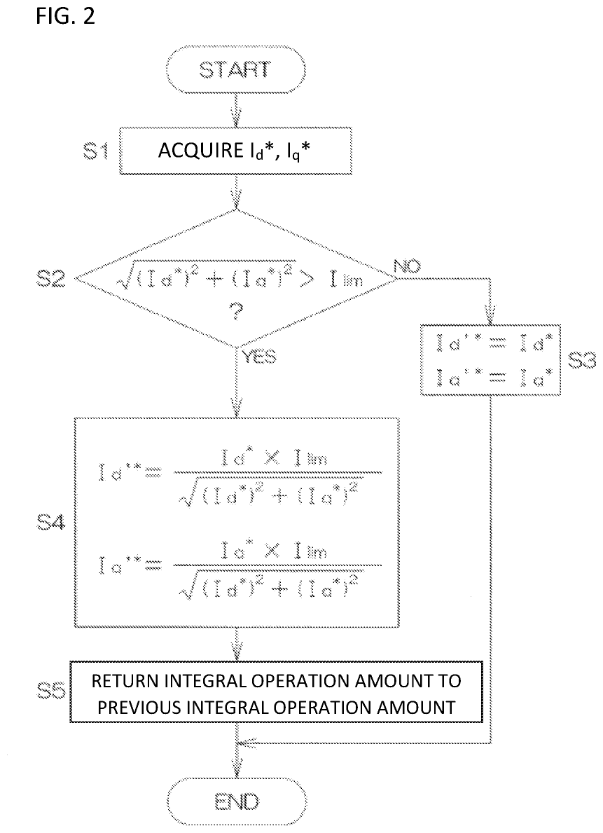

FIG. 2 is a flowchart illustrating the operation of the target current limiting unit 24. The processing illustrated in FIG. 2 is repeatedly executed in specified calculation cycles.

The target current limiting unit 24 acquires the d-axis target current I_{d}*, which is calculated by the d-axis PI control unit 23A, and the q-axis target current I_{q}*, which is calculated by the q-axis PI control unit 23B (step S1). In the following description, a combined current of the d-axis target current I_{d}* and the q-axis target current I_{q}* will be referred to as a target current I*.

Next, the target current limiting unit 24 determines whether a magnitude {(I_{d}*)²+(I_{q}*)²}^{1/2} of the target current I* is larger than a specified current limit value Iₗᵢₘ (Step S2).

If the magnitude {(I_{d}*)²+(I_{q}*)²}^{1/2} of the target current I* is equal to or smaller than the current limit value Iₗᵢₘ (step S2: NO), the target current limiting unit 24 proceeds to step S3.

In step S3, the target current limiting unit 24 outputs the d-axis target current I_{d}* and the q-axis target current I_{q}* as the d-axis target current I_{d}′* and the q-axis target current I_{q}′* after the current limit processing, respectively. Then, the target current limiting unit 24 terminates the processing in the current calculation cycle.

In step S2, if the magnitude {(I_{d}*)²+(I_{q}*)²}^{1/2} of the target current I* is larger than the current limit value Iₗᵢₘ (step S2: YES), the target current limiting unit 24 proceeds to step S4.

In step S4, the target current limiting unit 24 limits the target current I* to be equal to or smaller than the current limit value Iₗᵢₘ, which is set in advance. More specifically, the target current limiting unit 24 calculates and outputs the d-axis target current I_{d}′* and the q-axis target current I_{q}′* after the current limit processing on the basis of the following equations (1), (2).

I_{d}′*=I_{d}*×Iₗᵢₘ÷{(I_{d}*)²+(I_{q}*)²}^{1/2} (1)

I_{q}′*=I_{q}*×Iₗᵢₘ÷{(I_{d}*)²+(I_{q}*)²}^{1/2} (2)

In addition, the target current limiting unit 24 returns the integral operation amount, which is held by the integral elements 32A, 32B in the d-axis and q-axis PI control units 23A, 23B, to the previous integral operation amount (step S5). Then, the target current limiting unit 24 terminates the processing in the current calculation cycle.

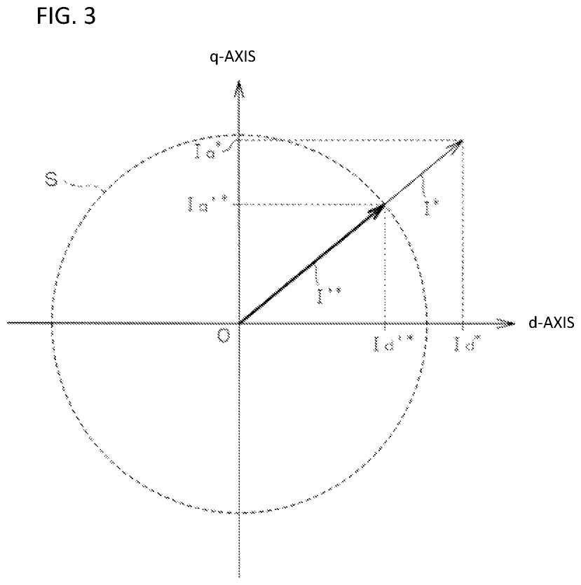

FIG. 3 is a schematic graph for illustrating the processing in step S4 of FIG. 2.

A broken circle S is a current limiting circle that is centered on an origin O of a dq coordinate system and has a radius of the current limit value Iₗᵢₘ. As illustrated in FIG. 3, when the magnitude of the target current I* (the combined current of the d-axis target current I_{d}* and the q-axis target current I_{q}*) is larger than the current limit value Iₗᵢₘ, the target current limiting unit 24 limits the d-axis target current I_{d}* and the q-axis target current I_{q}* such that the magnitude of the target current I* becomes equal to the current limit value Iₗᵢₘ. As a result, the d-axis target current after the limit process is I_{d}′* in FIG. 3, the q-axis target current after the limit process is I_{q}′* in FIG. 3, and the target current after the limit processing is I′* in FIG. 3.

A control device that does not include the target current limiting unit 24 will be used as a comparative example with respect to the control device 2 according to the above-described embodiment.

In the comparative example, when the switch 4 is turned on, a current (a load current) flowing through the electric motor 5 becomes larger than the reactor current. This is because the electric motor 5 is a load through which an inrush current flows. In such a case, the output voltage of the power conversion apparatus 1 is reduced, and thus the d-axis and q-axis output voltages Vd, Vq are reduced. As a result, the voltage deviations ΔV_{d}, ΔV_{d} are increased, and thus the d-axis and q-axis target currents I_{d}*, I_{q}* are increased. For this reason, the reactor current becomes equal to or larger than the overcurrent determination threshold, and the actuation of the power conversion apparatus 1 is stopped by the overcurrent protection function.

On the other hand, in the control device 2 according to the above-described embodiment, when the switch 4 is turned on, the current (the load current) flowing through the electric motor 5 is increased, and thus the target currents I_{d}*, I_{q}* are also increased. However, the target current limiting unit 24 limits each of the target currents I_{d}*, I_{q}* to be equal to or smaller than the current limit value Iₗᵢₘ. Then, the inverter 11 is controlled on the basis of the target currents I_{d}′*, I_{q}′* after the limit processing. Thus, the reactor current is limited, and the output voltage of the power conversion apparatus 1 is reduced.

As a result, the load current is limited. Then, when the load current becomes equal to the reactor current (a current limit value), the output voltage of the power conversion apparatus 1 maintains a reduced state. Thereafter, when the load current is reduced to be smaller than the reactor current (the current limit value), the output voltage of the power conversion apparatus 1 is increased. Then, when the reactor current becomes equal to the load current, the output voltage of the power conversion apparatus 1 is stabilized. Thus, according to the above-described embodiment, it is possible to suppress an overcurrent from flowing to the power conversion apparatus 1 at the time when the switch 4 is turned on. As a result, it is possible to suppress the overcurrent protection function from being implemented and stopping the actuation of the power conversion apparatus 1.

In the above-described embodiment, in the case where it is determined that the magnitude {(I_{d}*)²+(I_{q}*)²}^{1/2} of the target current I* is larger than the current limit value Iₗᵢₘ, the integral operation amounts held by the integral elements 32A, 32B are returned to the previously-calculated integral operation amounts (see step S5 in FIG. 2). In other words, when the target current I* is limited, updating of the integral operation amounts by the integral elements 32A, 32B is stopped. In this way, it is possible to prevent the integral operation amount, which is calculated by using the output voltage controlled by the target current after the limit processing, from being accumulated in each of the integral elements 32A, 32B. As a result, it is possible to prevent the integral operation amount from being calculated by using the unreliable past integral operation amount when the target current I* is no longer limited.

The description has been made so far on the embodiment of the present invention. However, the present invention can also be implemented in other embodiments. For example, in the above-described embodiment, the inverter 11 is the three-phase inverter. However, but the inverter 11 may be a single-phase inverter.

For example, the power conversion apparatus 1 may be a system-interconnection inverter that is used in a cogeneration system.

The detailed description has been made on the embodiment of the present invention. However, these are merely specific examples that are used to clarify technical contents of the present invention. The present invention should not be interpreted in a restrictive manner to these specific examples, and the scope of the present invention is limited only by the accompanying claims

This application corresponds to Japanese Patent Application No. 2018-156430 filed with the Japan Patent Office on Aug. 23, 2018, and the entire disclosure of the application is incorporated herein by reference.

### DESCRIPTION OF REFERENCE NUMERALS

1 power conversion apparatus

2 control device

3 DC power supply

4 switch

5 motor

11 inverter

12 LC filter

21A d-axis target voltage setting unit

21B q-axis target voltage setting unit

22A d-axis voltage deviation calculation unit

22B q-axis voltage deviation calculation unit

23A d-axis PI control unit

23B q-axis PI control unit

24 target current limiting unit

25 current control unit

32A, 32B integral element

1. A control device for a power conversion apparatus including an inverter that converts DC power into AC power, the control device for the power conversion apparatus comprising:
a current limiting unit that limits a target current value to be equal to or smaller than a specified limit value when the target current value is larger than the limit value; and
a control unit that controls the inverter on the basis of the target current value after current limit processing by the current limiting unit.

2. The control device for the power conversion apparatus according to claim 1 further comprising:
a PI control unit that calculates the target current value by performing a proportional integration calculation on a deviation between a specified target output voltage and an output voltage of the power conversion apparatus, wherein
the current limiting unit is configured to limit the target current value to be equal to or smaller than the limit value and stop updating of an integral operation amount by the PI control unit when the target current value is larger than the limit value.
